(19) United States
(12) Patent Application Publication
(10) Pub. No.: US 2016/0025364 A1
(43) Pub. Date: Jan. 28, 2016

(54) System And Apparatus For Integrated HVACR And Other Energy Efficiency And Demand Response

(71) Applicant: PACECONTROLS LLC, Philadelphia, PA (US)

(72) Inventors: Thomas A. MILLS,, JR., Philadelphia, PA (US); Stanley BUDNEY, Philadelphia, PA (US)

(73) Assignee: PaceControls, LLC, Philadelphia, PA (US)

(21) Appl. No.: 14/775,747

(22) PCT Filed: Mar. 14, 2014
(86) PCT No.: PCT/US14/28473

§ 371 Date: Sep. 14, 2015

Related U.S. Application Data
(60) Provisional application No. 61/799,501, filed on Mar. 15, 2013.

(51) Int. Cl. F24F 11/00; H02J 3/14; G05B 13/02

(52) U.S. Cl. CPC F24F 11/006; G05B 13/0265; H02J 3/14

(57) ABSTRACT

Electronic controller apparatus for automatically controlling and managing load demand and operation of energy-consuming equipment powered by alternating electrical power current, whereby feedback signals from a vapor compression evaporator or other source, and possibly other physical signals, are used to supplement the pre-fixed, learned, or default settings to optimize compressor operation (run time) in cooling and refrigeration equipment, and thereby to improve heat transfer in the evaporator. The effect is to improve the Energy Efficiency Ratio (EER), Seasonal Energy Efficiency Ratio (SEER), and Coefficient of Performance (COP) for the unit, and provide other advantages and improvements. In gas-, oil-, and propane-fired HVAC&R heating systems, the apparatus can also optimize burner operation and thereby improve heat transfer across the burner heat exchanger. HVAC&R systems that incorporate the demand controller and methods of their operation also are provided. The apparatus can also be applied to gas compression and compressed air control systems.

### BACKGROUND OF THE INVENTION

This application claims the benefit under 35 U.S.C. §119(e) of prior U.S. Provisional Patent Application No. 61/799,501, filed Mar. 15, 2013, which is incorporated in its entirety by reference herein.

The present invention relates to a system and apparatus for automatically controlling and optimizing electrically controlled energy-consuming equipment, including gas-, oil-, and propane-fired heating equipment controlled via electrically powered control systems. The present invention also relates to heating, ventilating, air conditioning, and refrigeration equipment systems incorporating the apparatus and methods of using the apparatus in such systems.

Heating, ventilating, air conditioning and/or refrigeration (“HVACR” or “HVAC&R”) control systems have been designed to perform two major functions: temperature regulation and dehumidification. Increased focus on carbon footprint and green technologies has led to numerous energy related improvements including more efficient refrigerants, variable speed compressors and fans, cycle modifications, and more efficient burners. Although some of these improvements can be found on many units of new HVAC&R equipment, there is a large installed base of older existing equipment still in operation but often unable to take advantage of these energy related improvements as retrofit improvements.

Common retrofit technologies that address energy usage include methodologies such as setpoint curtailment, temperature anticipation, equipment staging, variable speed fans, burners, and compressors, and closed loop load sensing instead of timer based. It is often difficult to retrofit existing installations with these methodologies because the methodologies are highly dependent on the HVAC&R equipment, configuration, and installation details. Adding a conventional energy saving methodology to an existing HVAC&R system can be costly and time consuming.

U.S. Pat. Nos. 5,687,139 and 5,426,620 (the Budney '139 and '620 patents) relate in part to a specially controlled switch in a control signal line of individual units of electrical equipment, such as a control signal line on a standard air conditioning unit, which combines a digital recycle counter with a control line of an electrical load. The digital recycle counter of the control device is used with pre-settings for providing the demand control on a wide range of electrically powered equipment. In addition to the indicated Budney patents, a number of other patents also relate to HVAC&R system and equipment power and demand control and management. In this regard, the present application incorporates by reference in their entireties each of the following: U.S. Pat. No. 5,426,620 (Budney), U.S. Pat. No. 5,687,139 (Budney), U.S. Pat. No. 7,177,728 (Gardner), U.S. Pat. No. 5,735,134 (Sheng Liu et al.), U.S. Pat. No. 6,658,373 (Rossi et al.), U.S. Lat. No. 5,261,247 (Knezic et al.), U.S. Pat. No. 5,996,361 (Bessler et al.), U.S. Pat. No. 5,669,222 (Jaster et al.), and U.S. Pat. No. 7,242,114 (Cannon et al.)

### SUMMARY OF THE PRESENT INVENTION

A feature of the present invention is to provide an apparatus for a heating, ventilating, air conditioning and/or refrigeration (HVAC&R) system that is controlled using feedback signals from a vapor compression evaporator and/or other source, and possibly other physical signals, which are used to supplement the pre-fixed, learned settings (via optimization and fuzzy logic programs), or default settings to optimize compressor operation (run time) in cooling and refrigeration equipment, and also thereby to improve heat transfer in the evaporator.

A further feature is to provide an apparatus which can optimize burner operation in gas-, oil- and propane-fired heating equipment in a similar fashion, and also thereby improve heat transfer across the burner's heat exchanger.

Another feature is to provide an apparatus which may be used to optimize compressor operation in compressed air, or other gas compression, operations.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to an electronic controller apparatus for automatically controlling and managing load demand and operation of energy-consuming equipment powered by alternating electrical power current, comprising: a) a controller switch connectible in series with a control signal line that connects with a load unit control switch that controls flow of operative power to a load unit, and the controller switch capable to open and close the control signal line; b) a digital recycle counter comprising a counter for generating a count of oscillations of an oscillating control signal in the control signal line, and capable for defining an elapsed run time interval and an elapsed idle time interval for the load unit; c) a digital timer for providing an input index of real time, and capable of defining an elapsed run time interval and an elapsed idle time interval for the load unit; d) a learning module for analysis of input information and derivation of algorithms for improved optimization of energy use and/or demand of the load unit, comprising at least one of initial default values and a lookup table, which is capable of ensuring that a load unit runs at no greater than a learned number of cycles per hour of operation under thermostatic load; e) an external conditioning device capable of communicating with at least one sensor for sensing at least one physical value related to a load unit cycle of the load unit and/or temperature of a space; f) an auctioneering control signal device capable of selecting a highest or lowest value from input signals obtained from two or more of b), c), d) and e) and outputting a selected signal as an auctioneered control signal to the controller switch, wherein feedback signals from the load unit are processable by the electronic controller apparatus to be used to supplement pre-fixed, learned settings or default settings to optimize load unit operation (run time) in cooling and refrigeration equipment, and also thereby to improve heat transfer in the evaporator, and also in similar fashion to optimize gas-, oil-, or propane-fired burner operation, and also compressed air or other gas compression operation.

The present invention also relates to a heating, ventilating, air conditioning or refrigeration (HVAC&R) system comprising the indicated control apparatus, a thermostat or other control signal source, and at least one HVAC&R load unit, operably connected to a power supply line.

The present invention also relates to a method for automatically controlling and managing load demand and operation of a HVAC&R load unit powered by electricity, comprising steps of electrically connecting the indicated control apparatus in a control signal line between a thermostat or other control signal source for a load device and an equipment load control switch for the load device.

It is to be understood that both the foregoing general description and the following detailed description are exemplary and explanatory only and are intended to provide a further explanation of the present invention, as claimed.

The accompanying drawings, which are incorporated in and constitute a part of this application, illustrate some of the embodiments of the present invention and together with the description, serve to explain the principles of the present invention.

### BRIEF DESCRIPTION OF DRAWINGS

FIG. 1 is a block/schematic diagram of a HVAC&R system including an electronic controller apparatus, according to an example of the present invention.

FIG. 2A is a plot showing operation of a 4-unit air conditioning system operating at design load under normal controls (amps and hours), and FIG. 2B is a plot showing a simulation under a building management system, showing operation of the same 4-unit air conditioning system under a prototype controller apparatus accordingly to an example of the present invention, and showing the reduced energy consumption for the same loading (amps and hours).

FIG. 3A is a labeled diagram showing the basic components and thermodynamic cycle of a vapor compression cooling or refrigeration system.

FIG. 3B is a labeled diagram showing the mechanical components of a vapor compression cooling or refrigeration system.

FIGS. 4A and 4B are plots showing trials of a controller apparatus according to a prototype example of the present invention in optimizing a gas-fired commercial domestic hot water boiler burner's operation (° F. and hours).

### DETAILED DESCRIPTION OF THE PRESENT INVENTION

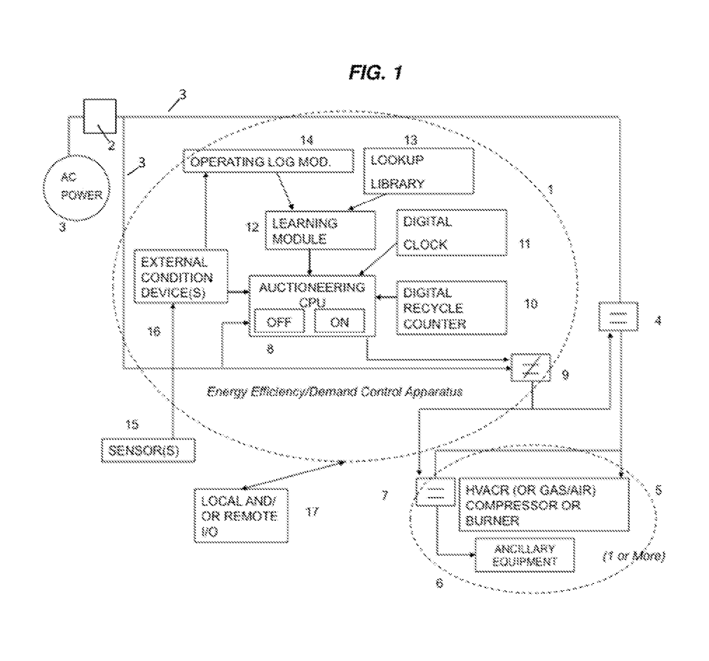

The present invention relates in part to an electronic controller apparatus for providing automatic control in an HVAC&R system or other electrically controlled cooling and/or heating systems, and/or a gas compression or compressed air system, and the like. The controller apparatus of the present invention can comprise the units enclosed within the dashed oval 1 in FIG. 1, labeled “Energy Efficiency/Demand Control Apparatus”. With reference to FIG. 1, AC power is supplied through power lines 3 via AC power meter 2, which measures electrical energy usage and demand of electrical energy at that location. Through load unit control switch 4, the AC power supplies an energy-consuming load unit 5—in the examples provided, an HVAC&R compressor or burner, or gas compression/compressed air compressor. The AC power also can supply ancillary equipment 6, through ancillary equipment control switch 7.

In the apparatus of the present invention within oval 1, the auctioneering central processing unit (CPU) 8 receives inputs from a multiplicity of sources, in determining the auctioneered best optimizing signal to optimizing controller switch 9. In the illustration of FIG. 1, these inputs include the digital recycle counter 10, the digital clock 11, and the learning module 12. The learning module 12, in turn, received inputs from a lookup library 13 of manufacturer data and historical algorithmic inputs relating to equipment energy optimization. The learning module 12 also receives inputs from an operating log module 14, which contains a running set of data on equipment operating variables that are obtained via sensors 15 (e.g., refrigerant mass flow rate sensor, temperature sensor, pressure sensor, and the like), as conditioned through external condition devices 16. The apparatus 1 can be operated, and its outputs and inputs viewed, via either local or remote input/output user interfaces 17 (e.g., a thermostat or other control signal source).

With the electronic controller apparatus of the present invention, feedback signals from a vapor compression evaporator or other source, and possibly other physical signals, can be used to supplement the pre-fixed, learned (via optimization and fuzzy logic programs), or default settings to optimize compressor operation (run time) in cooling and refrigeration equipment, and also thereby to improve heat transfer in the evaporator. The effect can be to improve the Energy Efficiency Ratio (EER), Seasonal Energy Efficiency Ratio (SEER), and Coefficient of Performance (COP) for the unit. Also, the electronic controller apparatus can allow a variety of supplemental commanded or other external system signals to alter these pre-fixed, learned, or default settings to deliver Demand Response and “smart grid” functionality. These external commanded control signals may be useful for extremely controlled “throttling back” of air conditioning or refrigeration energy consumption, subject to safeguards via external thermostatic sensors, to allow electric demand reduction at various levels (building sector, facility, or electrical grid sector). This demand controller apparatus and mechanism may also be useful for ensuring reliability of a set allocation of solar PV electrical power on the associated facility, such as an improvement to systems shown in U.S. Pat. No. 7,177,728, via a different mechanism and thermodynamic action, and to allow for optimization of gas-, oil-, or propane-fired equipment (fuel-fired heating), such as that used for space and water heating, and process heating. In the case of fuel-fired heating equipment, feedback signals from a supplemental temperature- or pressure-sensing device or sensor can be used to supplement the pre-fixed, learned, or default settings to optimize burner operation (run time) in fuel-fired heating equipment, and also thereby to improve heat transfer in the burner combustion space to the heating medium (air or water). Also, to allow a variety of supplemental commanded or other external system signals to alter these pre-fixed, learned, or default settings to deliver Demand Response and other functionality. The electronic controller apparatus of the present invention can provide even further improvements in energy efficiencies and/or demand control with respect to previous controller equipment for HVAC&R systems, such as those shown in the indicated '139 and '260 Budney patents.

Additionally, there have been recent concerns regarding security issues with networked, building-wide control systems with Internet connectivity. The present invention provides an elegant “single point energy management system” approach to deliver significant energy savings at the level of the unitary HVAC&R device, without the need for Internet-accessible networking.

As such, the electronic controller apparatus is uniquely suited to deliver all of the following, in an extraordinarily wide range of applications in heating, ventilating, air conditioning, and refrigeration (HVACR), and also in process cooling and heating, equipment, such as in the following:

Energy efficiency improvements in basic thermal cycles,

Integral compressor anti-short-cycling protection and other life-extension features, including optional soft starting circuitry,

Aggregated load diversification and demand reduction (for electrical, or also gas or other fossil fuel, distribution networks),

Finely controllable Demand Response functionality,

Ability to deliver additional load reduction and other functionality (e.g., PV Solar array optimization), in response to external commanded or system signals,

The application refers both to the device, and to the programming of the control circuitry. Thus, it can be utilized as both a retrofit device (embodiment), and as an enhancement to existing control circuitry by HVACR, and potentially other, original equipment manufacturers (OEMs). If embodied algorithmically in the control architecture of control systems, these control systems: can be at either the HVACR unit level, at the level of a building or campus, or a larger system; and/or can also be part of a wired or wireless network, i.e. a building management system or energy management system (BMS/EMS).

As a retrofit device, the electronic controller apparatus is an extraordinarily versatile HVAC&R “universal smart node”—able to deliver steady-state energy efficiency improvements for an wide range of cooling, refrigeration, and heating equipment; automatic or manual Demand Response for isolated or ISO-level “smart grid” activities, and PV Solar reliability optimization, much of this without need for expensive and laborious wired or wireless networking. The electronic controller apparatus can be embodied as a single unitary device including all the features that are enclosed in the larger oval shown in FIG. 1, or the controller apparatus may be embodied in several different parts that are operably connected together to function as described herein. The controller apparatus can include standard connectors (e.g., pin terminal connectors, or others) for signal inputs and signal outputs.

Operation in optimizing cooling or refrigeration operation

The vapor compression cooling/refrigeration (VCCR) unit's compressor(s) can run under an auctioneered control signal, which signal can be derived from the shorter of the following, as also shown by the diagram in FIG. 1:
a) an elapsed time interval, as defined either by a digital recycle counter or via a timing counter that initiates its count when the compressor in the vapor compression cycle starts,
b) a decrease in refrigerant mass flow rate, or a proxy variable for refrigerant mass flow rate, through the evaporator coil, from an initial level to a pre-fixed, learned, or default fraction of that level, or to a critical relative level obtained from a lookup table,
c) a change in another sensed physical value in the VCCR unit cycle, or
d) receipt of a thermostat-satisfied signal from the associated thermostatic sensing device.

The run times can be further auctioneered against a control mechanism that ensures that the VCCR compressors run at no greater than the following number of cycles per hour of operation under thermostatic load:
a) pre-fixed, learned, or default number (e.g., 6 times per hour), or
b) a number obtained from a lookup table.

An auctioneered control signal can be a signal outputted from a circuit device used to select the highest or lowest of a plurality of separate control signals and supply energy to a load in accordance with the selected control signal. Techniques for auctioneering control signals may be adapted for use in this respect. For example, see U.S. Pat. Nos. 2,725,549 and 3,184,611, which are incorporated herein in their entireties by reference.

The multiple comparison/ error signals above enhance compressor operation, and the fundamental optimizing timing control a) also assures electrical load diversity within a network, i.e. a synchronized operation. Thus, the mechanism can reduce or eliminate electrical load peaking from a group of VCCR devices without the necessity of a wired or wireless connection, while each device's energy efficiency is improved. This two-level improvement in electrical network operations (improved unit level energy efficiency plus reduced aggregated demand, on a real-time basis) is enhanced by this improvement optimizing mechanism.

The VCCR compressor(s) can run under the regimen described above, and then can be idled by the device. The duration of the idled interval can be under an auctioneered control signal, which signal can be derived from the longer of the following, as is also shown by the flowchart below:
a) an increase in evaporator coil discharge temperature from an initial level to a pre-fixed, learned, or default fractionally higher level (increased superheat, after state change and warming of the saturated refrigerant gas in the evaporator; that is, after change of state, vs. merely increasing superheat), or to a critical relative level obtained from a lookup table, e.g. one developed from OEM guidelines as to minimum idle times to avoid compressor short-cycling.
b) A pre-set, pre-derived, or learned elapsed time interval, as defined either by a digital recycle counter or via a recycle timer that initiates its count when the compressor in the vapor compression cycle stops (as further noted below, these time intervals can all reflect a body of knowledge and promulgations from compressor OEMs regarding minimum “off” times to avoid short-cycling—thus, this interval can add anti-short-cycling protection to the associated VCCR unit,
c) a change in another sensed physical value in the VCCR unit cycle, or
d) receipt of a thermostat-call signal from the associated thermostatic sensing device.

As with the run times, the VCCR compressor idle times can be further auctioneered against a control mechanism that ensures that the VCCR compressors run at no greater than the following number of cycles per hour of operation under thermostatic load:
a) a pre-fixed, learned, or default number (e.g., 6 times per hour), or
b) a number obtained from a lookup table

Upon receipt of a signal from a programmable thermostat with night setback, the device can also be able to extend “off” compressor cycles and/or shorten compressor “on” cycles in a similar manner to that for Demand Response (also see further description below), according to a set of pre-set, pre-derived, or learned elapsed time intervals as described above.

The device, as embodied as a retrofit and as in algorithmic form, is able to operate multiple staged compressors within a given VCCR unit.

A significant potential advantage of the device's optimized compressor operation, with anti-short-cycling, is enhanced protection from slugging (passage of liquid refrigerant into the compressor) and also from coil freezeover, as described below. As such, the charge of refrigerant may be able to be increased in a VCCR, thus providing more thermal mass in the system and thus more cooling capacity for the same electrical rating.

Another potential advantage of the device is its enhancement of economizer operations. A common problem of economizers is deterioration of humidity sensing, resulting in too-humid air being brought into the space—the device provides better control. Still another is the ability of the device to evaluate the effect of idling condenser fans and other ancillary equipment on VCCR operation, and then to idle them as well at intervals during VCCR operation. In addition to the additional energy savings, idling condenser fans can improve heat transfer by allowing higher refrigerant pressures to be maintained,

Further regarding use of recycle timer vs. real-time timer—the mechanism above requires a device that recycles (counts from 0 and resets), either a timer or a counter. Use of a timer will not do what a system using a digital recycle counter, such as shown in '139 and '620 Budney patents, can do.

The electronic controller apparatus or device offers a very low-cost, elegant way to at once a) allow optimizing cycling of individual compressors with no power requirement, and without interference with real-time control inputs, b) deliberately asynchronous operation of a cohort of compressors without the need for expensive wireless or wired controls, c) granular Demand Response functionality, and d) low-cost active or passive frequency-triggered load shedding. All in one base unit with, possibly, one or more low-cost peripherals.

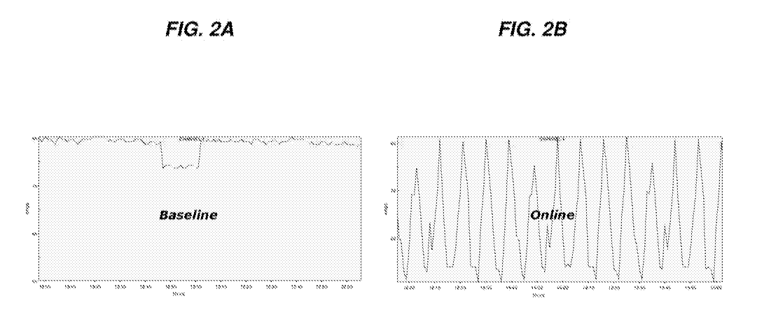

If a recycle timer is used solely in the electronic controller apparatus, it is possible to obtain some of the system benefits, but there will not be the assured diversification in time of electrical load operation, demonstrable with an asynchronous network composed of multiple electrical (cooling or refrigeration) loads, all optimized via a digital recycle counter that is based upon AC powerline frequency. This diversity can be seen and is useful, even within single electrical operating systems, e.g. a multiple compressor cooling unit. FIGS. 2A and 2B show the effect of such asynchronous network operation on the current draw as seen by the electric meter, of 4 large air conditioning units operating on a single electrical panel. FIG. 2A shows operation of a 4-unit air conditioning system operating at design load under normal controls (amps and hours), and FIG. 2B shows a controlled simulation under a building management system, showing operation of the same 4-unit air conditioning system under control of a prototype of a controller apparatus of the present invention (amps and hours). More specifically, the diagrams in FIGS. 2A and 2B show before/after metering of an electric panel powering 4 large (40-50 ton) package A/C units on a large distribution center, clearly showing average demand moving from ˜80 amps to ˜60 (actual current draw per phase is 4× shown, since there are 4 conductors per phase; thus, average current draw drops from ˜320 to ˜240 amps per phase, or a 25% reduction).

Further, regarding prior art on recycle timers which can be adapted for use in this application, they were first developed by SSAC (later ABB SSAC) as part of “RC” circuits for lights. This timing control mechanism proved unreliable, and SSAC then went to powerline frequency counting for diversity and synchronization. They cannot do it on time, since nothing that is being controlled in the HVACR unit such as configured in the present invention is working based on real time. Though work started out with real time indexing, then moved to recycle timers based on time (JO), these still do not allow the desired operation. Also, with recycle timers based on time, the compressor starts when power comes back on after a power outage, rather than letting the contactor close and then the optimizing counting begin. The result is that the compressor can be turned on and off rapidly, short-cycling it.

An embodiment of the indicated controller apparatus/device of the present invention, once installed by technician, may feature any or all of the indicated optimization setpoint options above, i.e.:
a) pre-set/pre-derived,
b) learned optimization based on either real-time back-looking inputs, or else a learning component over the first X equipment cycles,
c) values from a lookup table, or
d) other setpoint sources.

Thus, installation of the apparatus/device is uniquely facilitated as “set [or “install”] and forget“. Pre-fixed values sets may come from the factory, and values of a)-d) above may be able to be changed or overridden if the device is part of a wired or wireless network, i.e. a building management system or energy management system (BMS/EMS).

Flexibility in setpoint adjustment is necessary in the embodiment as a VCCR retrofit device, in that different equipment can have different time delays and operating parameters that must be taken into effect. It is particularly important not have inflexible pre-set minima, as existing control architecture may have limits: for instance, for a large ground source heat pump, the various time delays might require a quite short incremental idle period (e.g., an OFF period of 0.1 minute), though the total time idled might be closer to 2.8 minutes.

### Mechanism of Operation of the Device in Cooling and Refrigeration Cycles

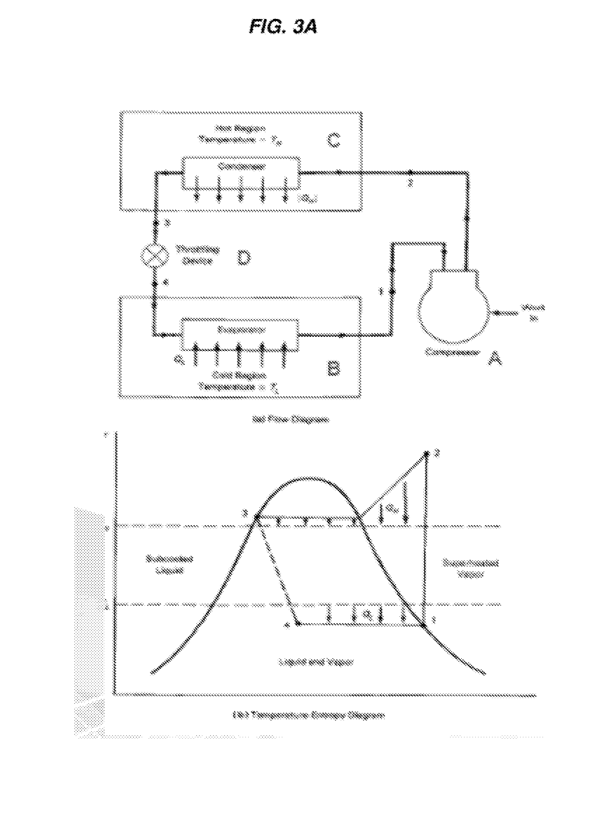

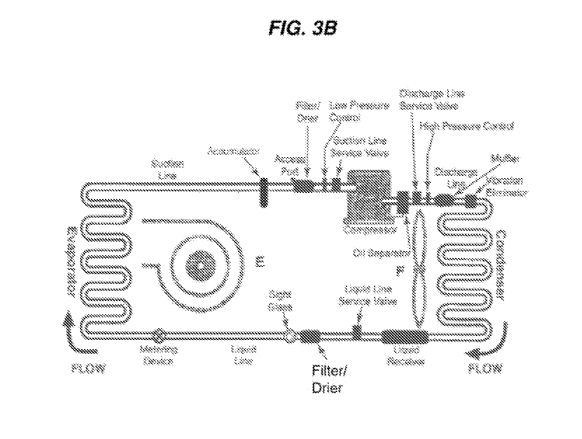

The effect can be to improve the basic vapor compression cooling cycle in a number of ways, chiefly the following: (1) making the evaporator heat transfer more efficient, thus increasing BTU's of heat transfer per minute of compressor run time, (2) largely eliminating coil freezeover, (3) reducing compressor motor average temperatures, (4) improving lubrication, and (5) programmatically eliminating short-cycling. FIGS. 3A-B are referred to for purposes of the following discussion. Briefly, the vapor compression cooling cycle is the basic technology for most air conditioning equipment, and nearly all refrigeration equipment. It is useful to think of cooling-cycle operation at the level of the molecules of R-22 (or R-410A, etc.) refrigerant in the cooling loop. A good explanation of the cooling cycle is as noted in Weston, Energy Conversion (Ch. 8, “Refrigeration and Air Conditioning,” West Engineering—Series, 1992), from which the diagrams shown in FIGS. 3A and 3B are based. The following is a step-by-step overview: (1) As the HVAC unit starts, the compressor (A) is doing the work of compressing the vapor refrigerant as it leaves the evaporator coils (B) in the cooled region, picking up heat as it goes through the coils. The subcooled (below boiling point) molecules of R-22 absorb heat in boiling to slightly superheated (above boiling point) vapor, as shown in the idealized temperature-entropy diagram of the vapor compression cycle as shown in FIG. 3A. (2) The compressed vapor then runs through the condenser (C), where it is condensed and gives up heat, then (3) goes through the HVAC unit's throttling device (D) usually in HVAC units of the size expected in these projects, a thermal expansion valve (TXV, TEV) or electronic orifice. The job of the TXV is to “provide the flow resistance necessary to maintain the pressure difference between the two heat exchangers (evaporator and condenser). It also serves to control the rate of flow from condenser to evaporator” (Weston, p. 284). Initially, the TXV is wide open, and the flow of R-22 through the evaporator is largely limited only by the pumping action of the compressor. As the HVAC unit runs, however, and the TXV closes down, 2 parallel and linked phenomena occur in the evaporator and compressor. First, there are fewer molecules of R-22 per unit time in the evaporator -- due to the greater throttling of the TXV -- and thus fewer molecules per unit time able to boil to vapor, thus less cooling per unit of compressor runtime. Second, the compressor meanwhile is now pumping against a higher downstream pressure -- in mechanical terms, pumping against a more-closed valve, and thus having to do more work to deliver the volume of coolant. This can lead to increased winding heating of the compressor motor, and these 2 phenomena will be seen with a wide variety of the positive-displacement compressor types used in HVAC equipment. Both contribute to reduced system efficiency, in terms of cooling delivered per unit time vs. electric energy consumed to deliver it.

What the retrofit unit (RU) does is provide a very flexible way to run the compressor for an optimized interval of time, during which a maximized quantity of R-22 is being vaporized per unit time, and then idle the compressor (the largest energy-consuming element in the cooling cycle) for a time specified by OEMs to eliminate short-cycling. During this OEM-specified OFF time -- typically only on the order of 3-4 minutes -- cooling and dehumidification continues as the ancillary equipment (blowers and fans, E and F in the diagram in FIG. 3B) continues to operate. The evaporator coil will warm up slightly, with 2 beneficial effects: (1) Reduction in incipient evaporator coil icing -- the first layer of crystal formation is critical to further coil icing, and reduced coil icing is a large ancillary benefit of RU installation. (2) When the compressor comes back on and R-22 is again injected into the evaporator coils, the slightly increased temperatures will improve the rate of boiling of the R-22 to vapor, thus the heating load removed per unit time.

The 2nd Low of Thermodynamics notes that (Weston, p. 271) “energy (heat) will not flow from cold to hot regions without assistance”, i.e. work added to the system. In vapor compression cooling cycles, that work is performed by the compressor, hence it is generally the largest energy-consuming device in the HVAC unit. The heat removed from the cooled space by the evaporator coil QL, and the heat rejected via the condenser coil QH, where h(i) is the enthalpy of the R-22 mass (lbs.) “M “, with mass flow rate (lb/hour) “m”, at points 1,2,3,4 on the temperature-entropy diagram in FIG. 3A, can be written as (e.g., Weston, p. 281):
Evaporator coil: QL/M=h1−h4
Condenser coil: QH/M=h2−h3
The compressor work W to cause this energy flow is then related to QL and QH, as: QL+QH=W, where QL and W (energy into system) are <0.
The evaporator coil heat transfer in BTUs, over time period “t”, can thus be given by:

$$\begin{matrix}QL = \int ( mass flow [ lb \text{/} hour ) * ( h 1 [ t ] - h 4 [ t ] ) * d t \\ = \int m ( t ) * d h ( t ) * d t .\end{matrix}$$

Evaporator coil heat transfer in BTUs, over time period “t” (cont'd):

$$\begin{matrix}QL = \int ( mass flow [ lb \text{/} hour ] ) * ( h 1 [ t ] - h 4 [ t ] ) * d t \\ = \int m ( t ) * d h ( t ) * d t .\end{matrix}$$

As a more detailed focus on the evaporator coil heat transfer:
1. The sensing bulb of the TXV (D) senses at point 1 the degree of superheat in the R-22 leaving the evaporator (B), and opens and closes to maintain a barrier of superheated vapor to the compressor, to avoid damage to the compressor from liquid R-22 entering it.
2. However, too much superheat gained in the coil means less liquid R-22 in the coil able to flash to vapor, to provide cooling—the R-22 is passing through the last part of the coil unable to deliver maximum cooling (via R-22 flashing to vapor). This can be seen in IR photographs of RU-retrofitted and non-retrofitted coils—in the latter case, a significant portion of the discharge end of the coil is red.
3. Also, higher superheats heat the compressor, with the consequent negative effects on compressor life. The RU, by optimizing compressor run time, also allows optimization of superheat conditions—the compressor idle time supplements the superheat in compressor protection, allowing for lower superheat with maintained compressor safety.
4. The result is a cooler coil, with more surface area devoted to R-22 vaporization vs. superheating—combined with higher average mass flow rate, means heat transfer QL is maintained.
5. Sequences in RU-retrofitted vs. “Baseline” A/C unit operation: Baseline: Compressor runs with TXV at first open, then closes down to maintain AP between evaporator and condenser; large superheat,
RU: Compressor runs with TXV open, then as TXV continues to close down, compressor idled for ˜3 minutes→T⇑P⇑ at Point 1, TXV opens again to increase R-22 mass flow into coil; when compressor re-starts, higher mass flow AND lower subcooling of inlet R-22, plus reduced superheat at outlet, result in enhanced heat transfer.
6. Thus, Baseline vs. RU-retrofitted heat transfer:

QL (Base Case)=∫m(t)*dh(t)*dt

⇄

QL(RU)=∫m(t)⇑*dh(t)⇑*dt⇓.

As the last equation in the description above shows, running the compressor during periods of enhanced mass flow rate (m(t)) and enthalpy change (dh(t)), and thus heat transfer per unit of compressor run time in the coil, allows maintenance of the total heat transferred by the coil (QL), even when compressor run time is reduced (dt).

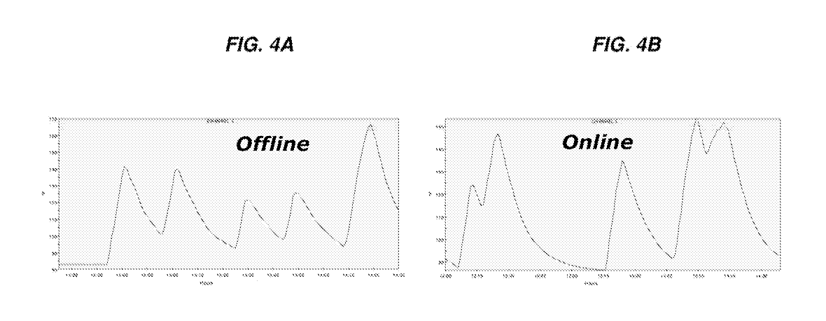

This is exactly what is shown in the controlled laboratory testing described in FIGS. 4A and 4B. The retrofit unit (RU) sets up warmer coils during the compressor-idle period, which can pick up more heat and can therefore cause more refrigerant to change state once admitted again.

This is in contrast with the typical VCCR configuration, where the evaporator coils are colder as the compressor starts to drive refrigerant through; as such, the refrigerant takes longer to change state (vaporize), and vaporization is the main mechanism of heat removal—not simply warming up of the sensible temperature of the refrigerant. The warmer the coil, within the limits created by the RU, the greater the mass change of state, with the related effects of refrigerant density via the lower average coil temperatures. And because the RU idles only the compressor, leaving the ancillary equipment (blowers and fans) operating normally, during the beneficial off period the heat from the room continues to upload to the coil.

These phenomena are also clearly visible in infrared thermography of VCCR evaporators with and without the device retrofitted. The action of the compressor optimization is to allow more linear surface of the compressor coil to be engaged in transferring latent heat of vaporization.

A large additional benefit of the RU to VCCR operations is reduction in coil freezeover, a major decrement to system energy efficiency. During an extensive empirical study, refrigerant evaporator coils were observed for when they began to frost after startup, and in the process build up an insulating barrier between the −40° F. below gas and 80° F. air (the outside air thus doesn't see −40° F., but rather 32° F. ice temperature). A frosted-over coil misses out on a tremendous delta-T of cooling and the rate of cooling directly proportional to delta-T, This is why parasitic heating approaches (either electric resistance heating, or hot gas bypass) are typically used in nearly all refrigeration, and in a great deal of air conditioning equipment.

Existing technology to improve energy efficiency of vapor compression cycles in general has focused on control, and in particular feedback, deficiencies—to work on measurement time lags, controller time lags, and to add more inputs. The described device, by comparison, focuses on the inherent thermodynamics of the heat transfer cycle -- while the feedback loop (thermostatic controls) remains as it is, in control. And it is done in a way using asynchronous digital control network principles, which also makes the technology of the present invention excellent as a low-cost, easily deployable “smart grid” demand response approach.

Mechanism of operation of the device in delivering Demand Response, Automated Demand Response and Load Reduction functionality

In the United States and other developed nations—and even more so in the rapidly developing economies of the world—a major driver of HVAC sales is the increasing acceptance of air conditioning, for decades considered a quasi-luxury in even parts of the developed world, as a necessity of daily life. Naturally, along with economic factors, the hotter climate regions exhibit this trend more strongly.

This shift in market acceptance has had a strong effect on the electric networks needed to supply all of this new cooling load. The problem is exacerbated by the fact that naturally, air conditioning loads in a region can tend to peak all at the same time, i.e. usually during the afternoon, when air-conditioned buildings have absorbed energy from the sun and the surrounding air during the morning. On very hot days, particularly in regions without adequate power generation facilities or, alternatively, transmission capacity to bring power in from outside the region, this HVAC peak load can lead to grid emergencies, brownouts, and rolling blackouts that produce considerable personal and economic disruption.

As an indication of the challenge, data from a New England electrical grid operator, ISO New England, for the years 2004-2005 showed the highest peak in total demand on the New England grid occurred, as would be expected, in July. What is interesting is that, although the year-over-year average demand 2004-5 rose 2%, the peak demand—which must be answered by regional generation or imported power—rose 11% on a year-over-year basis. And according to ISO New England, most of this new peak demand was for air conditioning. What is true in New England is also happening in California and the rest of the U.S., in Europe, India, China, and elsewhere in the world, and this peak demand is often answered by the most expensive (and in the developing world, often the dirtiest, i.e. oil and diesel) sources of power generation. CEC data shows clearly that on-peak carbon emissions are higher than off-peak, on a tons/MWh basis.

Utilities and grid operators are pursuing a number of strategies with regard to peak demand from A/C. In Demand Response, or voluntary curtailment, programs, facility owners sign up their buildings to be called upon, under certain conditions, if the local electrical network is being overloaded on a hot summer day. In an emergency declared by the regional electric grid operator, either manually or via specialized remote operating controls some of the enrolled facility's lighting and A/C equipment can be shut off or reduced in load, reducing electric load on the grid. The facility owner is usually paid in some combination of reduced electric rates, “standby payments”, and additional payments if actually called upon to reduce load. In the U.S., an actual curtailment event may happen not at all, or several times in a summer, depending on the local grid, its supply/demand balance, and the weather. The actual curtailment period is usually only limited to 4-6 hours in the afternoon of the event day. However, currently DR as a mitigator is still hindered by aggregation hurdles, market ignorance, difficulties and cost in technology deployment, M&V requirements, and other factors. Reference to automatic Demand Response as the ultimate goal, with device as being able to bridge many HVAC equipment to position of “spinning reserve”. The “smart grid” ideal is a bottom-up, fully automated basic system where the buildings do the load shedding.

As covered in the Budney '139 patent, the device as either an RU or an algorithmic embodiment can allow powerline-frequency based staggering on compressor run cycles between separate HVACR units.

As also covered in the Budney '139 patent, the RU can, on an active and/or passive basis, very flexibly EXTEND-OFF air conditioning and refrigeration compressor units, based on changes in sensed powerline frequency. That is, the RU can also deliver a highly granular Demand Response functionality to “throttle back” A/C during peak periods, in a way much superior to the “plug puller” technologies in the current art. The signal for an active DR action could be relayed in any number of ways, e.g. from the utility via a signal from the meter, or via a DR aggregator, via a signal sent via EMS, Internet link, or wireless or cellular network.

Thus, RU-equipped HVACR equipment could be part of a low-cost, easily deployable, and very flexible load-shedding program whereby at, e.g.: 59.X Hz: “Commercial A” load group goes into EXTEND-OFF mode (“Commercial A” could be, say, large refrigeration and commercial A/C loads with some excess capacity, or in non-critical areas)

59.Y Hz: “Commercial B” Load Group goes into EXTEND-OFF Mode

The device, either embodied as an RU actuator or as part of a system, can also deliver enhanced “Level 2” and “Level 3” Demand Response functionality, plus Automatic Demand Response functionality. It does this via the ability to go into a continuously variable EXTEND OFF compressor operation on a variety of automatic and sensed conditions. The Demand Response functionality can work as follows:
a) Level 2: On receipt of signal, 1 compressor (of multi-compressor HVACR unit) EXTEND-OFF idled for up to 6 hours
b) Level 3: (i) The RU unit can be installed as it normally is, with the EXTEND-RUN temperature sensor wired into the related return air duct airflow in order to extend compressor runtime past the basic RUN settings if return-air temperatures rise above a predetermined setpoint. The device can be set up with a current CT monitoring 1 phase of HACR unit current draw, and the EXTEND-RUN temperature probe monitoring return-air duct temperature. (ii) During normal DR Unit operation, the RU unit can deliver compressor efficiency improvements resulting in average demand reductions on the order of 10%-20%. (iii) Upon a series of signals from the DR coordination network:
1) the DR Units can first go into a brief “pre-cooling” sequence, to reduce the DR Units’ controlled-space temperatures by 1-2° F., then—
2) can shift to a “DR” sequence, using the RU unit's EXTEND-OFF feature, to de-energize the DR Units' compressors for intervals sufficient to achieve the required 30%-40% target average kW reduction, subject to—
3) the occupant-comfort protection provided by the EXTEND-RUN sensor on the RU unit, which can extend DR Unit compressor runtime if temperatures reach the abovementioned 80-82° F. band in the return air duct.
4) In addition to delivering the appropriate signals, the Unit on each HVACR unit can deliver line-current, return-air duct temperature, and status data upon whatever querying intervals are desired.
(iv) Alternative Level 3 sequence:
A) RU can incorporate as options: an electric meter, and an energy monitor.
B) RU can be responsive to return air temp, and can decide not to exercise control above a certain value.
C) Electric meter can record the energy use of three phases in one unit, and only one phase in others
D) Energy monitor can accept a pulse input from the electric meter, and maintain a perpetual register of electric use
E) Energy monitor data can be reported in to wireless gateway every 15 minutes
F) RU can record the time of operation for each stage of cooling and heating in perpetual registers
G) RU can also create a log of room air and outside air temperature to maintain a perpetual log of degree-days (or degree hours) that can be compared to run times for the purpose of estimating energy savings.
H) RU peripheral can also act as a router, listening at all times.
I) Demand Response can be executed by this system as follows:
   a1) Network coordinator can issue either a “Pre-cool” or a “Demand Response” command,
   a2) RU can hear command in near real time, and can respond by changing the set-point as programmed,
   a3) When the Energy monitor checks in, it can receive the “pre-cool” or “demand response” command, and can output:
   b1) If “Pre-cool” command, close relay as signal to Pace Controller to “EXTEND-RUN”,
   b2) If “Demand Response” command, close relay as signal to Pace Controller to “Extend-Off',
   a4) At the beginning and end of each “pre-cool” and “demand response” modes, RU and energy monitor can send their register values, so that the central computer can record the values during these critical periods separately from the general register use over extended periods of time.

In Demand Reduction and allocation: using the energy management system described by U.S. Pat. No. 7,177,728 to Gardner, the RU could be used as the actuator.

At the beginning and end of each “pre-cool” and “demand response” modes, RU and energy monitor can send their register values, so that the central computer can record the values during these critical periods separately from the general register use over extended periods of time.

### Mechanism of Operation of the Device in Fuel-Fired Heating Cycles

For gas-, oil-, and propane-fired burner control circuits, an improvement on the apparatus described in the referenced '139 and '260 Budney patents, whereby the same RU described above can receive feedback signals from a temperature or pressure sensor, or other source, to optimize burner run time in cooling and refrigeration equipment.

In heating applications, the device can essentially turn a less efficient burner into a more modern and efficient “interval-fired” system. “Standard-efficiency” burners can fire for extended periods to reach higher temperatures, for longer periods, than are necessary to meet thermostat setpoints. Natural gas and oil furnaces may heat the plenum to reach temperatures of 800° F+, exhausting much of the heat, while the thermostat is satisfied at much lower air temperatures of perhaps 70° F., or water temperatures of 160° F.

By interval-firing, i.e. more discrete porting of fuel into a combustion chamber per unit time, significant improvements in heat transfer efficiency can be made in the 90% of heating equipment that is “standard efficiency” (i.e. with burner architectures that convert approximately 80% of the fuel's chemical energy to useful heat). The device thus produces improvements in combustion chamber fuel utilization and heat transfer, within the confines of existing control architecture and with preservation of all safety, startup, and shutdown mechanisms. In the same manner as for cooling applications, the firing sequence programming can follow all appropriate boiler OEM guidelines for cycles per hour, minimum cycle times, and other factors.

The effect of the device is thus to reduce wasted heat in burner firing, which otherwise goes up the stack, while also maintaining stack conditions so that condensation and other factors are avoided. FIGS. 4A and 4B show the effect of the device on a light commercial gas-fired domestic hot water heater based on laboratory testing The data log shows boiler flue exhaust temperature as a proxy for burner firing time and also combustion chamber temperature, during periods of matching day and time one week apart (Thursdays, 12:00-2:30 pm). The graph in FIG. 4A shows the boiler firing 5 times in the “offline” series, versus the exact same number (5), though shorter, firing intervals in the online series shown in FIG. 4B, and with more efficient fuel utilization (heat transferred to hot water), shown by longer “off” times—all while still under thermostat's control.

### Additional Features of the Present Invention

The device can “fail safe” on a diagnosed failure of any of: a) mass flow rate sensing device; b) EPROM; c) DRC or DRT; or d) failure of other software or hardware component.

In “failing safe”, if any of the following events happen, the associated HVACR equipment can return to operation as normal, unless otherwise programmed.

The device can also assist the associated HVACR equipment in “re-starting safe”, on loss of power or on selected types of power transient, in such a way as to provide “hardening” of the grid to such congestion and demand-related events. This can be a base-unit feature in addition to all other “smart grid” features (Automatic behavior on power outage).

The device, in RU embodiment, can have local visible indications of “off”/“on” and working status.

In the RU embodiment, 1 RU can be able to handle up to 3 compressors, i.e. for a staged multiple-compressor VCCR equipment.

The device can be able (via MODBUS, BACnet and possibly other EMS/BMS protocols) to be remotely resettable and operable. Via a clip-on current and voltage transducers, or other means of monitoring line power draws, it can be possible to monitor energy consumption of the associated HVACR unit. Easy inputs and outputs.

In the RU embodiment, the unit can be easily manually set.

The device reduces reliance on thermal sensors as a feedback source in energy efficiency. This is a novel and positive element, in that thermal sensors are known to become less sensitive and need to be recalibrated over time.

The present invention includes the following aspects/embodiments/features in any order and/or in any combination:
1. The present invention relates to an electronic controller apparatus for automatically controlling and managing load demand and operation of energy-consuming equipment powered by alternating electrical power current, comprising:

a) a controller switch connectible in series with a control signal line that connects with a load unit control switch that controls flow of operative power to a load unit, and the controller switch capable to open and close the control signal line;

b) a digital recycle counter comprising a counter for generating a count of oscillations of an oscillating control signal in the control signal line, and capable for defining an elapsed run time interval and an elapsed idle time interval for the load unit;

c) a digital timer for providing an input index of real time, and capable of defining an elapsed run time interval and an elapsed idle time interval for the load unit;

d) a learning module for analysis of input information and derivation of algorithms for improved optimization of energy use and/or demand of the load unit, comprising at least one of initial default values and a lookup table, which is capable of ensuring that a load unit runs at no greater than a learned number of cycles per hour of operation under thermostatic load;

e) an external conditioning device capable of communicating with at least one sensor for sensing at least one physical value related to a load unit cycle of the load unit and/or temperature of a space;

f) an auctioneering control signal device capable of selecting a highest or lowest value from input signals obtained from two or more of b), c), d) and e) and outputting a selected signal as an auctioneered control signal to the controller switch, wherein feedback signals from the load unit are processable by the electronic controller apparatus to be used to supplement pre-fixed, learned settings or default settings to optimize load unit operation (run time).
2. The electronic controller apparatus of any preceding or following embodiment/feature/aspect, wherein the load unit comprises a vapor compression cooling/refrigeration (VCCR) unit's compressor run under the auctioneered control signal, wherein the auctioneered control signal is derived from the shorter of:

1) an elapsed time interval, as defined either by the digital recycle counter or via the recycle timer that initiates a count when the compressor in the vapor compression cycle starts;

2) a sensed decrease in refrigerant mass flow rate or a proxy variable for refrigerant mass flow rate, through an evaporator coil, from an initial level to a pre-fixed, learned, or default fraction of that level, or to a critical relative level obtained from the lookup table;

3) a change in a different sensed physical value than in 2) in the VCCR unit cycle; or

4) receipt of an OEM thermostat-satisfied signal from an associated thermostatic sensing device.
3. The electronic controller apparatus of any preceding or following embodiment/feature/aspect, wherein load unit run times are further auctioneered against a control mechanism that ensures that the VCCR compressors run at no greater than a following number of cycles per hour of operation under thermostatic load:

i) a pre-fixed, learned, or default number, or

ii) a number obtained from the lookup table.
4. The electronic controller apparatus of any preceding or following embodiment/feature/aspect, wherein after the VCCR compressor is run under the load unit run times, then the load unit is idled for an interval wherein duration of the idled interval is determined under an auctioneered control signal, wherein the idled interval signal is derived from the longer of the following:

a) an increase in evaporator coil discharge temperature from an initial level to a pre-fixed, learned, or default fractionally higher level, or to a critical relative level obtained from a lookup table;

b) a pre-set, pre-derived, or learned elapsed time interval, as defined either by the digital recycle counter or via the recycle timer that initiates its count when the compressor in the vapor compression cycle stops;

c) a change in another sensed physical value in the VCCR unit cycle; or

d) receipt of an OEM thermostat-call signal from the associated thermostatic sensing device.
5. The electronic controller apparatus of any preceding or following embodiment/feature/aspect, wherein load unit idle times are further auctioneered against a control mechanism that ensures that the VCCR compressors run at no greater than a following number of cycles per hour of operation under thermostatic load:

i) a pre-fixed, learned, or default number, or

ii) a number obtained from the lookup table.
6. The electronic controller apparatus of any preceding or following embodiment/feature/aspect, wherein a variety of supplemental commanded or other external system signals are used to alter the pre-fixed, learned, or default settings to deliver Demand Response and smart grid functionality.
7. The electronic controller apparatus of any preceding or following embodiment/feature/aspect, wherein the apparatus is capable of being applied as an actuator to increase useful the reliability of a set allocation of solar PV electrical power on an associated facility.
8. The electronic controller apparatus of any preceding or following embodiment/feature/aspect, wherein an optimizing action provided using the apparatus on a VCCR compressor operation and on evaporator heat transfer also serve to reduce or eliminate coil freezeover, by allowing the coil to warm up slightly between compressor-driven refrigerant pumping.
9. The electronic controller apparatus of any preceding or following embodiment/feature/aspect, wherein enhanced protection from slugging (passage of liquid refrigerant into the compressor) and also from coil freeze-over is obtained using the apparatus which allows the charge of refrigerant to be increased in a VCCR, thus providing more thermal mass in the system and thus more cooling capacity for the same electrical rating.
10. The electronic controller apparatus of any preceding or following embodiment/feature/aspect, wherein the apparatus is capable of being used for evaluation of an effect of idling condenser fans and other ancillary equipment on VCCR operation, and then to idle them as well at intervals during VCCR operation to allow additional energy savings, and also improve heat transfer by allowing higher refrigerant pressures to be maintained.
11. The electronic controller apparatus of any preceding or following embodiment/feature/aspect, wherein via a different mechanism and thermodynamic action, using the apparatus for fuel-fired heating, wherein feedback signals from a supplemental temperature- or pressure-sensing device are usable to supplement the pre-fixed, learned, or default settings to optimize burner operation (run time) in the fuel-fired heating equipment and also thereby to improve heat transfer in the burner combustion space to the heating medium (air or water).
12. The electronic controller apparatus of any preceding or following embodiment/feature/aspect, whereby a variety of supplemental commanded or other external system signals can be applied to alter the pre-fixed, learned, or default settings to deliver Demand Response and other functionality.
13. The electronic controller apparatus of any preceding or following embodiment/feature/aspect, wherein the apparatus is capable of providing anti-short-cycling protection to associated compressor or burner equipment.
14. The electronic controller apparatus of any preceding or following embodiment/feature/aspect, wherein the learning features of control architecture of the apparatus facilitate installation of the apparatus.
15. The electronic controller apparatus of any preceding or following embodiment/feature/aspect, wherein the apparatus reduces reliance on thermal sensors and humidity sensors as a feedback source in an HVAC&R system as compared to the HVAC&R system operating without the apparatus.
16. The present invention relates to a heating, ventilating, air conditioning or refrigeration (HVAC&R) system comprising a heating, ventilating, air conditioning or refrigeration unit and the electronic controller apparatus of claim 1 that intercepts a thermostat control signal of the HVAC&R system for processing the intercepted thermostat command to generate an adjusted control signal as an output signal for a load unit of the HVAC&R system.
17. The present invention relates to a system for automatic control of an HVAC&R system, comprising:

a thermostat (or other control signal source);

an electronic controller apparatus, and

at least one of load unit operably connected to a power supply line,

wherein the electronic controller apparatus is capable of being interposed in a control signal line between a control signal source and a load of the equipment to be controlled, the electronic controller apparatus comprising:
a) a controller switch in series with a control signal line that connects with a load unit control switch that controls flow of operative power to a load unit, and the controller switch capable to open and close the control signal line;
b) a digital recycle counter comprising a counter for generating a count of oscillations of an oscillating control signal in the control signal line, and capable for defining an elapsed run time interval and an elapsed idle time interval for the load unit;
c) a digital timer for providing an input index of real time, and capable of defining an elapsed run time interval and an elapsed idle time interval for the load unit;
d) a learning module for analysis of input information and derivation of algorithms for improved optimization of energy use and/or demand of the load unit, comprising at least one of initial default values and a lookup table, which is capable of ensuring that a load unit runs at no greater than a learned number of cycles per hour of operation under thermostatic load;
e) an external conditioning device capable of communicating with at least one sensor for sensing at least one physical value related to a load unit cycle of the load unit and/or temperature of a space;
f) an auctioneering control signal device capable of selecting a highest or lowest value from input signals obtained from two or more of b), c), d) and e) and outputting a selected signal as an auctioneered control signal to the controller switch, wherein feedback signals from the load unit are processable by the electronic controller apparatus to be used to supplement pre-fixed, learned settings or default settings to optimize load unit operation (run time).
18. The system of any preceding or following embodiment/feature/aspect, wherein the HVAC&R system comprises a gas compression/compressed air system (e.g., a VCCR system).
19. The present invention relates to a method for automatically controlling and managing power usage and/or load demand and operation of at least one load unit powered by electricity in an HVAC&R system, comprising the steps of:

electrically connecting an electronic controller apparatus in a control signal line between a thermostat (or other control signal source) and a load of the equipment to be controlled, wherein the electronic controller apparatus comprising a) a controller switch in series with a control signal line that connects with a load unit control switch that controls flow of operative power to a load unit, and the controller switch capable to open and close the control signal line, b) a digital recycle counter comprising a counter for generating a count of oscillations of an oscillating control signal in the control signal line, and capable for defining an elapsed run time interval and an elapsed idle time interval for the load unit, c) a digital timer for providing an input index of real time, and capable of defining an elapsed run time interval and an elapsed idle time interval for the load unit, d) a learning module for analysis of input information and derivation of algorithms for improved optimization of energy use and/or demand of the load unit, comprising at least one of initial default values and a lookup table, which is capable of ensuring that a load unit runs at no greater than a learned number of cycles per hour of operation under thermostatic load, e) an external conditioning device capable of communicating with at least one sensor for sensing at least one physical value related to a load unit cycle of the load unit and/or temperature of a space, f) an auctioneering control signal device capable of selecting a highest or lowest value from input signals obtained from two or more of b), c), d) and e) and outputting a selected signal as an auctioneered control signal to the controller switch, wherein feedback signals from the load unit are processable by the electronic controller apparatus to be used to supplement pre-fixed, learned settings or default settings to optimize load unit operation (run time);

intercepting at least one thermostat command from the thermostat for cooling, refrigeration, or heating at the electronic controller apparatus;

processing the intercepted thermostat command at the electronic controller apparatus to generate an adjusted control signal as an output signal; and

outputting the output signal generated by the electronic controller apparatus to the controller switch to control operation of the load unit.
20. The method of any preceding or following embodiment/feature/aspect, wherein the HVAC&R system comprises a gas compression/compressed air system (e.g., a VCCR system).

The present invention can include any combination of these various features or embodiments above and/or below as set forth in sentences and/or paragraphs. Any combination of disclosed features herein is considered part of the present invention and no limitation is intended with respect to combinable features.

The entire contents of all references cited in this disclosure are incorporated herein in their entireties, by reference. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. An electronic controller apparatus for automatically controlling and managing load demand and operation of energy-consuming equipment powered by alternating electrical power current, comprising:
a) a controller switch connectible in series with a control signal line that connects with a load unit control switch that controls flow of operative power to a load unit, and the controller switch capable to open and close the control signal line;
b) a digital recycle counter comprising a counter for generating a count of oscillations of an oscillating control signal in the control signal line, and capable for defining an elapsed run time interval and an elapsed idle time interval for the load unit;
c) a digital timer for providing an input index of real time, and capable of defining an elapsed run time interval and an elapsed idle time interval for the load unit;
d) a learning module for analysis of input information and derivation of algorithms for improved optimization of energy use and/or demand of the load unit, comprising at least one of initial default values and a lookup table, which is capable of ensuring that a load unit runs at no greater than a learned number of cycles per hour of operation under thermostatic load;
e) an external conditioning device capable of communicating with at least one sensor for sensing at least one physical value related to a load unit cycle of the load unit and/or temperature of a space;
f) an auctioneering control signal device capable of selecting a highest or lowest value from input signals obtained from two or more of b), c), d) and e) and outputting a selected signal as an auctioneered control signal to the controller switch, Attorney Docket No. 3161-005-01 wherein feedback signals from the load unit are processable by the electronic controller apparatus to be used to supplement pre-fixed, learned settings or default settings to optimize load unit operation time.

2. The electronic controller apparatus of claim 1, wherein the load unit comprises a vapor compression cooling/refrigeration (VCCR) unit's compressor run under the auctioneered control signal, wherein the auctioneered control signal is derived from the shorter of:
1) an elapsed time interval, as defined either by the digital recycle counter or via the recycle timer that initiates a count when the compressor in the vapor compression cycle starts;
2) a sensed decrease in refrigerant mass flow rate or a proxy variable for refrigerant mass flow rate, through an evaporator coil, from an initial level to a pre-fixed, learned, or default fraction of that level, or to a critical relative level obtained from the lookup table;
3) a change in a different sensed physical value than in 2) in the VCCR unit cycle; or 4) receipt of an OEM thermostat-satisfied signal from an associated thermostatic sensing device.

3. The electronic controller apparatus of claim 2, wherein load unit run times are further auctioneered against a control mechanism that ensures that the VCCR compressors run at no greater than a following number of cycles per hour of operation under thermostatic load:
i) a pre-fixed, learned, or default number, or ii) a number obtained from the lookup table.

4. The electronic controller apparatus of claim 2, wherein after the VCCR compressor is run under the load unit run times, then the load unit is idled for an interval wherein duration of the idled interval is determined under an auctioneered control signal, wherein the idled interval signal is derived from the longer of the following: a) an increase in evaporator coil discharge temperature from an initial level to a pre-fixed, learned, or default fractionally higher level, or to a critical relative level obtained from a lookup table;
b) a pre-set, pre-derived, or learned elapsed time interval, as defined either by the digital recycle counter or via the recycle timer that initiates its count when the compressor in the vapor compression cycle stops;
c) a change in another sensed physical value in the VCCR unit cycle; or d) receipt of an OEM thermostat-call signal from the associated thermostatic sensing device.

5. The electronic controller apparatus of claim 4, wherein load unit idle times are further auctioneered against a control mechanism that ensures that the VCCR compressors run at no greater than a following number of cycles per hour of operation under thermostatic load:
i) a pre-fixed, learned, or default number, or ii) a number obtained from the lookup table.

6. The electronic controller apparatus of claim 1, wherein a variety of supplemental commanded or other external system signals are used to alter the pre-fixed, learned, or default settings to deliver Demand Response and smart grid functionality.

7. The electronic controller apparatus of claims 1, wherein the apparatus is capable of being applied as an actuator to increase useful the reliability of a set allocation of solar PV electrical power on an associated facility.

8. The electronic controller apparatus of claim 1, wherein an optimizing action provided using the apparatus on a VCCR compressor operation and on evaporator heat Attorney Docket No. 3161-005-01 transfer also serve to reduce or eliminate coil freezeover, by allowing the coil to warm up slightly between compressor-driven refrigerant pumping.

9. The electronic controller apparatus of claim 1, wherein enhanced protection from slugging (passage of liquid refrigerant into the compressor) and also from coil freeze-over is obtained using the apparatus which allows the charge of refrigerant to be increased in a VCCR, thus providing more thermal mass in the system and thus more cooling capacity for the same electrical rating.

10. The electronic controller apparatus of claim 1, wherein the apparatus is capable of being used for evaluation of an effect of idling condenser fans and other ancillary equipment on VCCR operation, and then to idle them as well at intervals during VCCR operation to allow additional energy savings, and also improve heat transfer by allowing higher refrigerant pressures to be maintained.

11. The electronic controller apparatus of claim 1, wherein via a different mechanism and thermodynamic action, using the apparatus for fuel-fired heating, wherein feedback signals from a supplemental temperature- or pressure-sensing device are usable to supplement the pre-fixed, learned, or default settings to optimize burner operation (run time) in the fuel-fired heating equipment and also thereby to improve heat transfer in the burner combustion space to the heating medium (air or water).

12. The electronic controller apparatus of claim 11, whereby a variety of supplemental commanded or other external system signals can be applied to alter the pre-fixed, learned, or default settings to deliver Demand Response and other functionality. Attorney Docket No. 3161-005-01

13. The electronic controller apparatus of claims 1, wherein the apparatus is capable of providing anti-short-cycling protection to associated compressor or burner equipment.

14. The electronic controller apparatus of claim 1, wherein the learning features of control architecture of the apparatus facilitate installation of the apparatus.

15. The electronic controller apparatus of claim 1, wherein the apparatus reduces reliance on thermal sensors and humidity sensors as a feedback source in an HVAC&R system as compared to the HVAC&R system operating without the apparatus.

16. A heating, ventilating, air conditioning or refrigeration (HVAC&R) system comprising a heating, ventilating, air conditioning or refrigeration unit and the electronic controller apparatus of claim 1 that intercepts a thermostat control signal of the HVAC&R system for processing the intercepted thermostat command to generate an adjusted control signal as an output signal for a load unit of the HVAC&R system.

17. A system for automatic control of an HVAC&R system, comprising:
a thermostat;
an electronic controller apparatus, and at least one of load unit operably connected to a power supply line, wherein the electronic controller apparatus is capable of being interposed in a control signal line between a control signal source and a load of the equipment to be controlled, the electronic controller apparatus comprising:
a) a controller switch in series with a control signal line that connects with a load unit control switch that controls flow of operative power to a load unit, and the controller switch capable to open and close the control signal line;
Attorney Docket No. 3161-005-01 b) a digital recycle counter comprising a counter for generating a count of oscillations of an oscillating control signal in the control signal line, and capable for defining an elapsed run time interval and an elapsed idle time interval for the load unit;
c) a digital timer for providing an input index of real time, and capable of defining an elapsed run time interval and an elapsed idle time interval for the load unit;
d) a learning module for analysis of input information and derivation of algorithms for improved optimization of energy use and/or demand of the load unit, comprising at least one of initial default values and a lookup table, which is capable of ensuring that a load unit runs at no greater than a learned number of cycles per hour of operation under thermostatic load;
e) an external conditioning device capable of communicating with at least one sensor for sensing at least one physical value related to a load unit cycle of the load unit and/or temperature of a space;
f) an auctioneering control signal device capable of selecting a highest or lowest value from input signals obtained from two or more of b), c), d) and e) and outputting a selected signal as an auctioneered control signal to the controller switch, wherein feedback signals from the load unit are processable by the electronic controller apparatus to be used to supplement pre-fixed, learned settings or default settings to optimize load unit operation.

18. The system of claim 17, wherein the HVAC&R system comprises a gas compression/compressed air system.

19. A method for automatically controlling and managing power usage and/or load demand and operation of at least one load unit powered by electricity in an HVAC&R system, comprising the steps of:
Attorney Docket No. 3161-005-01 electrically connecting an electronic controller apparatus in a control signal line between a thermostat and a load of the equipment to be controlled, wherein the electronic controller apparatus comprising a) a controller switch in series with a control signal line that connects with a load unit control switch that controls flow of operative power to a load unit, and the controller switch capable to open and close the control signal line, b) a digital recycle counter comprising a counter for generating a count of oscillations of an oscillating control signal in the control signal line, and capable for defining an elapsed run time interval and an elapsed idle time interval for the load unit, c) a digital timer for providing an input index of real time, and capable of defining an elapsed run time interval and an elapsed idle time interval for the load unit, d) a learning module for analysis of input information and derivation of algorithms for improved optimization of energy use and/or demand of the load unit, comprising at least one of initial default values and a lookup table, which is capable of ensuring that a load unit runs at no greater than a learned number of cycles per hour of operation under thermostatic load, e) an external conditioning device capable of communicating with at least one sensor for sensing at least one physical value related to a load unit cycle of the load unit and/or temperature of a space, f) an auctioneering control signal device capable of selecting a highest or lowest value from input signals obtained from two or more of b), c), d) and e) and outputting a selected signal as an auctioneered control signal to the controller switch, wherein feedback signals from the load unit are processable by the electronic controller apparatus to be used to supplement pre-fixed, learned settings or default settings to optimize load unit operation (run time);
intercepting at least one thermostat command from the thermostat for cooling, refrigeration, or heating at the electronic controller apparatus;
processing the intercepted thermostat command at the electronic controller apparatus to generate an adjusted control signal as an output signal; and
Attorney Docket No. 3161-005-01 outputting the output signal generated by the electronic controller apparatus to the controller switch to control operation of the load unit.

20. The method of claim 19, wherein the HVAC&R system comprises a gas compression/compressed air system.
